(19) United States
(12) Patent Application Publication
(10) Pub. No.: US 2018/0179091 A1
(43) Pub. Date: Jun. 28, 2018

(54) SOLID CARBON SOURCE, BIOREACTOR HAVING THE SAME AND METHOD FOR WASTEWATER TREATMENT USING THE SAME

(71) Applicant: INDUSTRIAL TECHNOLOGY RESEARCH INSTITUTE, Hsinchu (TW)

(72) Inventors: Guan-You Lin, Hsinchu (TW); Ting-Ting Chang, Hsinchu (TW); Sheng-Ju Liao, Hsinchu (TW); Yu-Ting Liu, Hsinchu (TW)

(21) Appl. No.: 15/823,828

(22) Filed: Nov. 28, 2017

Related U.S. Application Data
(60) Provisional application No. 62/439,194, filed on Dec. 27, 2016.

(30) Foreign Application Priority Data
Dec. 27, 2016 (TW) 105143340
Sep. 29, 2017 (TW) 106133656

(51) Int. Cl. C02F 3/30; C08L 3/02; C08L 67/04; C08L 67/00

(52) U.S. Cl. CPC C02F 3/305; C08L 3/02; C02F 2305/06; C08L 67/00; C08L 67/04

(57) ABSTRACT

The present disclosure provides a solid carbon source, including: a plurality of bar-shaped units, each of the bar-shaped units having at least one turning portion which constitutes a position limiting region; and a plurality of gaps formed between any two of the bar-shaped units for a gas or liquid passage, wherein at least one of the bar-shaped units is disposed in the position limiting region of adjacent bar-shaped units, such that the plurality of bar-shaped units are integrated to a frame structure, and each of the bar-shaped units is formed by a composite material having a density of more than 0.9 g/cm³. A bioreactor having the same and a method for wastewater treatment using the same are also provided.

### CROSS-REFERENCE TO RELATED APPLICATION

The present application is based on, and claims priority from, Taiwan Application Serial Number, TW 105143340 filed on Dec. 27, 2016, TW 106133656 filed on Sep. 29, 2017, and U.S. Provisional Application No. 62/439,194, filed Dec. 27, 2016, the disclosure of which is hereby incorporated by reference herein in its entirety.

### TECHNICAL FIELD

The present disclosure relates to solid carbon sources for treating wastewater, a bioreactor having the same and a method for wastewater treatment using the same.

### BACKGROUND

With the rise of living standards and environmental awareness, the importance on wastewater and sewage treatment is increasing. In general, the treatment of wastewater containing nitrate nitrogen (NO₃—N) can be categorized into chemical treatment methods (such as treatments involving ion exchange, reverse osmosis, electrodialysis or zero-valent metals) and biological treatment methods (e.g. activated sludge method). The chemical treatment methods usually have the problem of secondary pollution. The use of the biological treatment method (biological nitrogen removal process) allows nitrate nitrogen to turn into non-polluting nitrogen emissions, eliminating the issue of secondary pollution.

Among biological treatment methods of wastewater containing ammonium nitrogen, the traditional nitrification and denitrification process is most commonly used. The nitrification and denitrification process involves oxidizing ammonium nitrogen into nitrate or nitrite by nitrifying bacteria or nitrosating bacteria in an aerobic environment, and then reducing nitrate or nitrite in an anaerobic environment by denitrifying bacteria to nitrogen emissions. However, the denitrifying bacteria are heterotrophic bacteria, meaning that there needs for a certain amount of carbon source in the wastewater to be used as its energy source. If there is not enough carbon source in the wastewater, it needs to be externally added.

However, the current methods for providing the carbon source often use organic solvents (such as methanol) as an external carbon source. It is flammable and volatile, which often causes public safety problems. Furthermore, in order to maintain the level of carbon source needed by microorganisms in the denitrification process, in the current treatment methods, an excessive amount of methanol is usually added. This not only wastes too much carbon source, but also results in high chemical oxygen demand (COD) value in the effluent. In this case, an aerobic biological treatment system for the effluent has to be further added to remove or reduce the residual organic matters (such as the excess carbon source), in order to meet the standard for water discharge.

Therefore, it is an urgent issue on how to provide a nitrification and denitrification process that provides enough carbon source without being discharged into the effluent as a solid carbon source.

### SUMMARY

The present disclosure provides a solid carbon source, including: a plurality of bar-shaped units, each of which having at least a turning portion constituting a position limiting region, and at least another bar-shaped unit being disposed in the position limiting region of the bar-shaped unit, and the plurality of bar-shaped units being integrated to form a frame structure; and a plurality of gaps formed between any two of the bar-shaped units for allowing gas or liquid to pass therethrough, wherein the bar-shaped units are made of a composite material having a density of greater than 0.9 g/cm³.

The present disclosure further provides a bioreactor, including: a body having a retention space, a reaction area within the retention space, an inlet in communication with the retention space, and an outlet in communication with the retention space; and the solid carbon source of the present disclosure placed in the reaction area, wherein the reaction area includes a fluid passage formed from the plurality of gaps, and the fluid passage is in communication with the inlet and the outlet.

The present disclosure further provides a method for wastewater treatment, including bringing wastewater, an activated sludge and the solid carbon source of the present disclosure into contact with one another to allow the wastewater to flow through the plurality of gaps to obtain treated wastewater.

### BRIEF DESCRIPTION OF DRAWINGS

FIG. 1 is a schematic diagram depicting a portion of the solid carbon source in accordance with the present disclosure;

FIG. 2 is a set of schematic diagrams depicting various implementations of the turning portion of the bar-shaped unit in the solid carbon source in accordance with the present disclosure, wherein A to F are respectively a schematic diagram depicting one of the various implementations of the turning portion of the bar-shaped unit;

FIG. 3 is a picture of the solid carbon source in accordance with the present disclosure;

FIG. 4 is a schematic diagram depicting a side view of a bioreactor in accordance with the present disclosure;

FIG. 5 is a graph depicting changes in the chemical oxygen demand (COD), the nitrate nitrogen content and the pH value in wastewater in accordance with Embodiment 1 of the present disclosure;

FIG. 6 is a graph depicting changes in the volume load and the removal rate of nitrate nitrogen in wastewater in accordance with Embodiment 1 of the present disclosure;

FIG. 7 is a graph depicting changes in the COD and the nitrate nitrogen content in wastewater in accordance with Embodiment 2 of the present disclosure;

FIG. 8 is a graph depicting changes in the volume load and the removal rate of nitrate nitrogen in wastewater in accordance with Embodiment 2 of the present disclosure;

FIG. 9 is a graph depicting changes in the COD and the nitrate nitrogen content in wastewater in accordance with Embodiment 3 of the present disclosure;

FIG. 10 is a graph depicting changes in the volume load and the removal rate of nitrate nitrogen in wastewater in accordance with Embodiment 3 of the present disclosure;

FIG. 11 is a graph depicting changes in the COD, the nitrate nitrogen content and the pH value in wastewater in accordance with Embodiment 4 of the present disclosure;

FIG. 12 is a graph depicting changes in the volume load and the removal rate of nitrate nitrogen in wastewater in accordance with Embodiment 4 of the present disclosure;

FIG. 13 is a graph depicting changes in the COD, the nitrate nitrogen content and the pH value in wastewater in accordance with Embodiment 5 of the present disclosure; and

FIG. 14 is a graph depicting changes in the volume load and the removal rate of nitrate nitrogen in wastewater in accordance with Embodiment 5 of the present disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

In the present disclosure, the term “position limiting region” mentioned in the present disclosure refers to an area or a range delineated by the inner edge of a turning portion, or a range jointly delineated by the inner edge of a turning portion and an extension portion, such that displacement of a bar-shaped unit passing through this range is limited.

In the present disclosure, the term “volume loading of nitrate nitrogen” refers to the total amount of nitrogen that can be processed per ton of tank each day. The unit of the total amount of nitrogen is kg-N/m³·day.

The present disclosure may also be practiced or applied with other different implementations. Based on different views and applications, the various details in this specification can be modified and changed without departing from the spirit of the present disclosure.

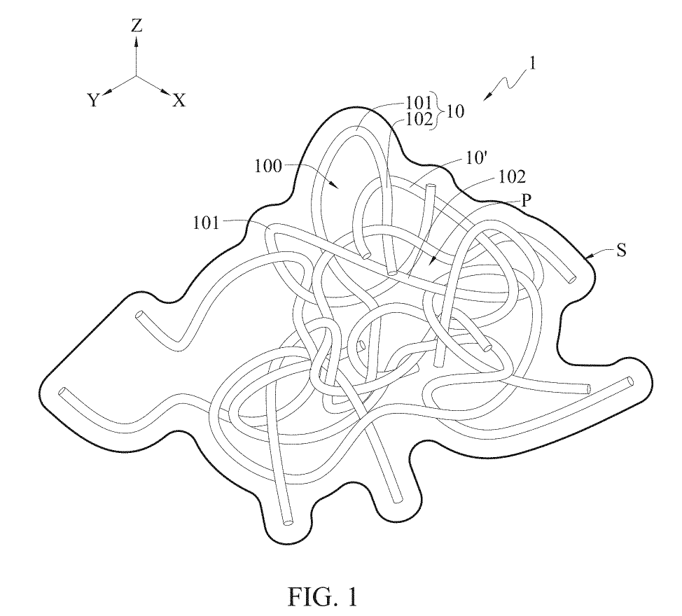

Referring to FIGS. 1 to 3, a solid carbon source 1 of the present disclosure includes a plurality of bar-shaped units 10, 10′, each of the bar-shaped unit 10 having at least one turning portion 101 which constitutes a position limiting region 100, and at least another bar-shaped unit 10′ being disposed in the position limiting region 100 of a bar-shaped unit 10, such that the plurality of bar-shaped units 10, 10′ are integrated to form a frame structure; and a plurality of gaps formed between any two of the bar-shaped units 10, 10′ for a gas or liquid passage, wherein each of the bar-shaped units 10, 10′ is formed by a composite material having a density of greater than 0.9 g/cm³. When applying the solid carbon source of the present disclosure, the frame structure is surrounded by a microbial reaction area S, and the plurality of gaps form a fluid passage P for wastewater.

In an embodiment, each of the bar-shaped units 10, 10′ includes a plurality of turning portions 101. For example, each of the bar-shaped units 10, 10′ includes at least one extension portion 102 for connecting the turning portion 101.

In another embodiment, the position limiting region 100 is constituted by both of the turning portion 101 and the extension portion 102.

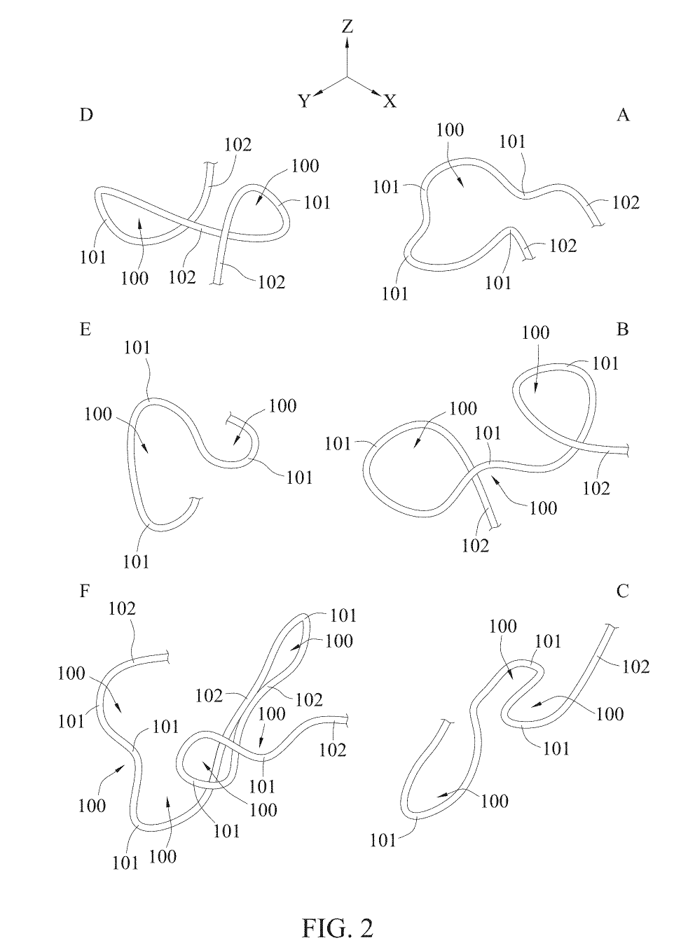

In yet another embodiment, each of the bar-shaped units extends on different coordinates of the three-dimensional (3D) space. More specifically, the bar-shaped units are arranged in offset to and/or wound around one another, such that plurality of bar-shaped units are integrated to form a frame structure. As shown in FIGS. 1 and 2, the turning portions 101 and the extension portions 102 of each of the bar-shaped units can be positioned on the same plane or different planes, and have different x-axis (X in the diagram), y-axis (Y in the diagram), z-axis (Z in the diagram) 3D coordinates.

For example, FIG. 2 illustrates different combinations of the turning portions 101 and extension portions 102. As shown in FIG. 2, the turning portions 101 and the extension portion 102 may have numerous different arrangements. As shown in FIG. 2A, a position limiting region 100 can be formed by a plurality of turning portions 101, which has an extension portion 102. As shown in FIG. 2B, the bar-shaped unit includes two extension portions 102 and three turning portions 101. Since the degree of bending of the middle turning portion 101 is small, a broader position limiting region 100 is formed. On the other hand, the other two position limiting regions 100 are smaller. As shown in FIG. 2C, from right to left, there is an extension portion 102 and three consecutive turning portions 101. In this example, each turning portion 101 delineates a position limiting region 100. Therefore, three turning portions 101 create three position limiting region 100. Moreover, as described before, the ends of two turning portions 101 can be connected without an extension portion 102 between the two turning portions 101.

Referring to FIG. 2D, from right to left, there is an extension portion 102, a turning portion 101 (forming a position limiting region 100), an extension portion 102, and another turning portion 101 (forming another position limiting region 100). As shown in FIG. 2E, from right to left, there is a turning portion 101 (forming a position limiting region 100), a reversed turning portion 101 (forming another position limiting region 100), and another turning portion 101 (and its position limiting region 100) wound in the same direction as the previous turning portion 101. The example in FIG. 2F includes an extension portion 102, two consecutive turning portions 101, an extension portion 102, a turning portions 101, an extension portion 102, three consecutive turning portions 101 and another extension portion 102.

In the exemplary embodiments described above, the extension portions 102 and turning portions 101 are all wound in the 3D space. Taken FIG. 2F as an example, two extension portions 102 appear to be touching each other, but they are actually displaced from each other, with one in front of the other (i.e. having different Y coordinates). Therefore, the two extension portions 102 are not in contact with each other.

In other embodiments, there is at least one connecting portion, for example, a connecting point (or contact point) among the plurality of bar-shaped units, which allows the frame structure formed by the plurality of bar-shaped units to be more stable. For example, connecting portions among the plurality of bar-shaped units allow at least two bar-shaped units to be physically joined (for example, nested or wedged) or chemically joined (for example, via an adhesive).

In yet another embodiment, the solid carbon source is formed by at least two bar-shaped units. Each of the bar-shaped units extends along different coordinates of the 3D space in that it bends or winds around itself or with another bar-shaped unit.

According to the embodiments of the solid carbon source of the present disclosure described before and shown in FIG. 1, each bar-shaped unit has a plurality of turning portions to provide several position limiting regions, and thereby strengthening the solid carbon source after the bar-shaped units are constructed and preventing the bar-shaped units from detaching from the frame structure of the solid carbon source. Moreover, this allows the solid carbon source to have certain compression elasticity that makes it easier to be placed in a bioreactor.

In an embodiment, the material for forming the bar-shaped units may include starch and biodegradable polymers. The weight ratio of the starch to the biodegradable polymers may be from 3:7 to 7:3. If the proportion of the starch is too high, overflow of too much carbon sources may occur, which leads to the chemical oxygen demand (COD) being too high in the effluent. If the proportion of the starch is too low, the carbon source in the system is insufficient to be used by the microbes, resulting in poor performance of the wastewater treatment.

In another embodiment, the material for forming the bar-shaped units may consist of starch and biodegradable polymers, and the weight ratio of the starch to the biodegradable polymers may be between 3:7 and 7:3.

In the previous embodiment, the starch can be modified or unmodified starch, wherein the unmodified starch includes, but is not limited to, corn starch, tapioca starch and potato starch, and the modified starch includes, but is not limited to, polyol-modified starch, esterified starch and etherified starch, for example, the polyols may be glycerol, sorbitol or polyethylene glycol (PEG).

In the previous embodiment, the biodegradable polymers can be at least one selected from a group consisting of polycaprolactone (PCL), polylactic acid (PLA), poly(butylene adipate-co-terephthalate) (PBAT), polybutylene succinate (PBS) and poly(butylene succinate-co-adipate) (PBSA).

In an implementation of the preparation of the bar-shaped units, a starch (e.g. thermoplastic starch (TPS)) and polycaprolactone (PCL) are fed into a twin screw extruder. The extrusion is carried out at a screw speed of 30 rpm to 250 rpm per hour at a temperature of between 60° C. to 190° C. Then, the extrudate is rotated and/or bent in 3D random orientations in water to form a solid carbon source having a plurality of bar-shaped units containing a plurality of turning portions.

According to the preparation method above, in an embodiment, the composite material is a porous composite material. The porosity of the composite material is between 10% and 50%, based on the total volume of the composite material. In one embodiment, the composite material has a specific surface area of 100 cm²/g to 1000 cm²/g.

In another specific embodiment, the density of the composite material is between 0.95 g/cm³ and 1.2 g/cm³.

In still another specific embodiment, the aspect ratios of the bar-shaped units are between 40:1 and 1000:1. In one embodiment, the lengths of the bar-shaped units are between 20 cm to 100 cm, and the diameters of the bar-shaped units are between 1 mm and 5 mm.

The present disclosure further provides a method for wastewater treatment, including the steps of: bringing wastewater, an activated sludge and a solid carbon source in accordance to the present disclosure into contact, allowing the wastewater to flow through the plurality of gaps to obtain treated wastewater.

In one embodiment, under a volume loading condition of 0.4 kg-N/m³·day to 1.0 kg-N/m³·day, the wastewater, the activated sludge and the solid carbon source of the present disclosure are brought into contact to allow the wastewater to flow through the plurality of gaps. In addition, the volume loading may also be 0.4 kg-N/m³·day to 0.8 kg-N/m³·day, 0.4 kg-N/m³·day to 0.7 kg-N/m³·day, 0.6 kg-N/m³·day to 0.8 kg-N/m³·day or 0.7 kg-N/m³·day to 0.8 kg-N/m³·day

In one embodiment, the wastewater contains nitrate nitrogen of 50 mg/L to 600 mg/L, for example, 50 mg/L to 450 mg/L.

In one embodiment, the pH value of the wastewater is between 6.5 and 8.0.

In one embodiment, the COD value of the treated wastewater is less than 100 mg/L, for example, less than 50 mg/L.

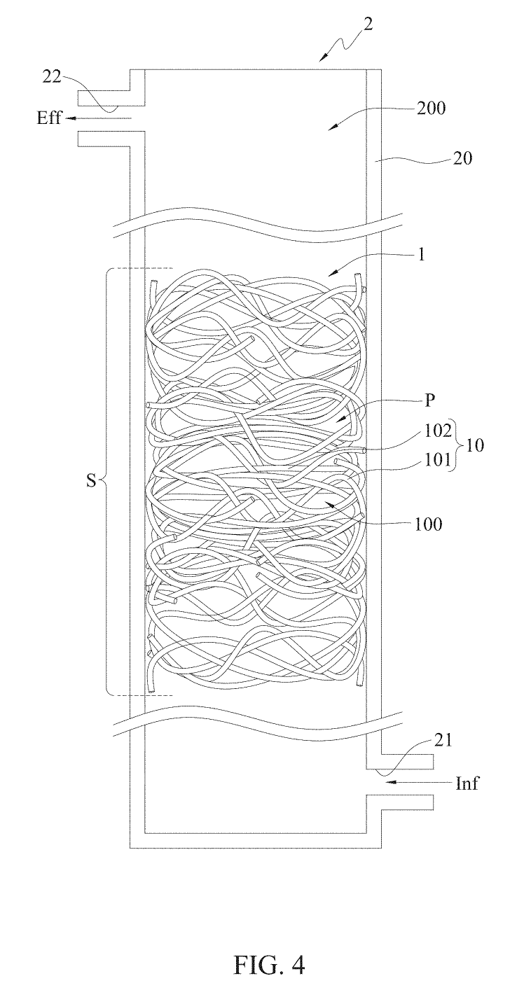

In order for the method for wastewater treatment of the present disclosure to have better performance, referring to FIG. 4, a bioreactor 2 is provided by the present disclosure, which includes: a body 20 including a retention space 200, a reaction area S within the retention space 200, an inlet 21 in communication with the retention space 200, an outlet 22 in communication with the retention space 200, and the solid carbon source 1 of the present disclosure placed in the reaction area S, wherein the reaction area S includes a fluid passage P formed of a plurality of gaps, and the fluid passage P is in communication with the inlet 21 and the outlet 22. For example, the fluid passage P consists of a plurality of gaps between a plurality of bar-shaped units 10, 10′ in the solid carbon source 1 (as shown in FIG. 1) and the remaining gaps not filled by the solid carbon source 1 in the reaction area S.

In one embodiment, based on the total volume of the retention space 200, the volume of the reaction area S is between 50% and 80%. In this embodiment, based on the total volume of the reaction area S, the total volume of the bar-shaped units 10, 10′ is between 20% and 60%, and the total volume of the fluid passage P is between 40% and 80%.

By making the density of the composite material forming the bar-shaped units greater than 0.9 g/cm³, the present disclosure allows the solid carbon source to be retained in the water, while providing a good carbon source.

In addition, the bar-shaped units of the solid carbon source of the present disclosure create a plurality of position limiting regions through the turning portions. These position limiting regions keep a certain percentage of space in the solid carbon source, and by offsetting or winding the bar-shaped units with respect to one another, the integrated frame structure retains gaps having gap distances between neighboring bar-shaped units larger than the diameter of the bar-shaped units, the plurality of gaps can be used as a fluid passage that allows liquid to flow through or gas to be discharged to prevent build-up of gas. This allows nitrogen gas created during the reaction to be discharged, and further prevents nitrogen gas from lifting the solid carbon source out of the surface of the water, so that the solid carbon source will not easily flow out with the effluent.

### Test Example

Elongation:

Tensile strength and elongation were measured according to ASTM D638 standard.

Volume of Reaction Area:

The volume of the solid carbon source 1 was filled in the reactor. Taken Embodiment 1 as an example, a cylindrical reactor of 377 cm³ was filled with a solid carbon source of 95 g. The volume filled was 377 cm³×60%, so the volume of the solid carbon source filled was 226.2 cm³.

Volume of Fluid Passage:

The volume of the reaction area deducted the volume of the solid carbon source. Again, taken Embodiment 1 as an example, the volume of the solid carbon source filled was 226.2 cm³ (377 cm³×60%), the total volume of the plurality of bar-shaped units of the solid carbon source was 93.1 cm³ (95 g÷1.02 g/cm³), so in Embodiment 1, the volume of the fluid passage in the reaction area was 133.1 cm³.

### Preparation Example 1: Preparation of a Solid Carbon Source of the Present Disclosure (50% TPS/50% PCL)

750 g of thermoplastic starch (TPS) and 750 g of polycaprolactone (PCL) were fed to a twin screw extruder, so that the TPS and PCL contents accounted for 50 wt % and 50 wt % of the total composite material, respectively. The extrudate was extruded at a temperature of 90° C. and a screw speed of 120 rpm per hour. The extrudate was rotated and/or turned in 3D random orientations in water to form a fibrous network-like solid carbon source having a plurality of bar-shaped units having a plurality of turning portions. The density of the solid carbon source was 1.02 g/cm³, the diameter was 2 mm, the porosity was 17.64% (about 18%) (wherein the closed-cell rate was 4.44% (about 4%) and the open-cell rate was 13.81% (about 14%)), and the specific surface area was 273 cm²/g.

In this preparation example, the TPS was prepared by mixing 100 phr (parts per hundred resin) of tapioca starch with 40 phr of water and 20 phr of glycerin at 60° C., and the mixture was heated to 70° C. using a single screw forced granulator for 8 minutes to obtain modified thermoplastic starch particles.

In the preparation example 1, the tensile strength of the solid carbon source was 36 kgf/cm², and the elongation was 4.54%.

### Preparation Example 2: Preparation of a Solid Carbon Source of the Present Disclosure (60% TPS/40% PCL)

900 g of thermoplastic starch (TPS) and 600 g of polycaprolactone (PCL) were fed to a twin screw extruder, so that the TPS and PCL contents accounted for 60 wt % and 40 wt % of the total composite material, respectively. The extrudate was extruded at a temperature of 90° C. and a screw speed of 120 rpm per hour. The extrudate was rotated and/or turned in 3D random orientations in water to form a fibrous network-like solid carbon source having a plurality of bar-shaped units having a plurality of turning portions. The density of the solid carbon source was 1.09 g/cm³, the diameter was 2 mm, the porosity was 25.63% (about 26%) (wherein the closed-cell rate was 2.38% (about 2%) and the open-cell rate was 23.82% (about 24%)), and the specific surface area was 356 cm²/g.

In this preparation example, the TPS was prepared by mixing 100 phr (parts per hundred resin) of tapioca starch with 40 phr of water and 20 phr of glycerin at 60° C., and the mixture was heated to 70° C. using a single screw forced granulator for 8 minutes to obtain modified thermoplastic starch particles.

In the preparation example 2, the tensile strength of the solid carbon source was 35 kgf/cm², and the elongation was 3.95%.

### Preparation Example 3: Preparation of a Solid Carbon Source of the Present Disclosure (70% TPS/30% PCL)

1050 g of thermoplastic starch (TPS) and 450 g of polycaprolactone (PCL) were fed to a twin screw extruder, so that the TPS and PCL contents accounted for 70 wt % and 30 wt % of the total composite material, respectively. The extrudate was extruded at a temperature of 90° C. and a screw speed of 120 rpm per hour. The extrudate was rotated and/or turned in 3D random orientations in water to form a fibrous network-like solid carbon source having a plurality of bar-shaped units having a plurality of turning portions. The density of the solid carbon source was 1.10 g/cm³, the diameter was 2 mm, the porosity was 9.64% (about 10%) (wherein the closed-cell rate was 0.56% (about 1%) and the open-cell rate was 9.13% (about 9%)), and the specific surface area was 951 cm²/g.

In this preparation example, the TPS was prepared by mixing 100 phr (parts per hundred resin) of tapioca starch with 40 phr of water and 20 phr of glycerin at 60° C., and the mixture was heated to 70° C. using a single screw forced granulator for 8 minutes to obtain modified thermoplastic starch particles.

In the preparation example 3, the tensile strength of the solid carbon source was 31 kgf/cm², and the elongation was 3.19%.

### Preparation Example 4: Preparation of a Solid Carbon Source of the Present Disclosure (50% TPS/50% PBAT)

750 g of thermoplastic starch (TPS) and 750 g of poly(butylene adipate-co-terephthalate) (PBAT) were fed to a twin screw extruder, so that the TPS and PBAT contents accounted for 50 wt % and 50 wt % of the total composite material, respectively. The extrudate was extruded at a temperature of 140° C. at a screw speed of 150 rpm per hour. The extrudate was rotated and/or turned in 3D random orientations in water to form a fibrous network-like solid carbon source having a plurality of bar-shaped units having a plurality of turning portions. The density of the solid carbon source was 1.05 g/cm³ and the diameter was 2 mm.

In this preparation example, the TPS was prepared by mixing 100 phr (parts per hundred resin (or rubber) of tapioca starch with 35 phr of water and 15 phr of glycerin at 80° C., and the mixture was heated to 90° C. using a single screw forced granulator for 10 minutes to obtain modified thermoplastic starch particles.

In the preparation example 4, the tensile strength of the solid carbon source was 66 kgf/cm², and the elongation was 51%.

### Preparation Example 5: Preparation of a Solid Carbon Source of the Present Disclosure (50% TPS/50% PLA)

750 g of thermoplastic starch (TPS) and 750 g of polylactic acid (PLA) were fed to a twin screw extruder, so that the TPS and PLA contents accounted for 50 wt % and 50 wt % of the total composite material, respectively. The extrudate was extruded at a temperature of 170° C. at a screw speed of 250 rpm per hour. The extrudate was rotated and/or turned in 3D random orientations in water to form a fibrous network-like solid carbon source having a plurality of bar-shaped units having a plurality of turning portions. The density of the solid carbon source was 0.99 g/cm³, and the diameter was 2 mm.

In this embodiment, the TPS was prepared by mixing 100 phr (parts per hundred resin (or rubber) of tapioca starch with 50 phr of water and 25 phr of glycerin at 95° C., and the mixture was heated to 100° C. using a single screw forced granulator for 30 minutes to obtain modified thermoplastic starch particles.

In the preparation example 5, the tensile strength of the solid carbon source was 40 kgf/cm², and the elongation was 0.99%.

In the previously disclosed preparation example, the step of mixing the tapioca starch, water and glycerin may also include mixing in a temperature between 30° C. and 95° C. using a kneader for 5 minutes to 30 minutes, and leave it standing at a temperature between 70° C. and 130° C. for 3 minutes to 20 minutes to form granules, and thereby obtaining modified thermoplastic starch particles.

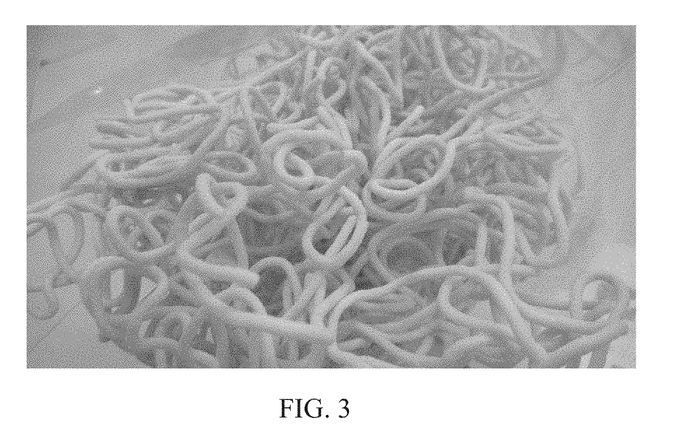

In this embodiment, the extrudate was rotated and/or turned in 3D (i.e. the x axis, y axis and z axis) random orientations in water. For example, when the extrudate was discharged in the y-axis direction (that is, perpendicular to the plane formed by the x-axis and z-axis), the direction for winding was moved along the x-axis and then turned towards the z-axis, and further turned in a direction opposite to the discharged direction so that it was wound towards the y-axis direction, and further moved in the z-axis direction to form a fiber-network solid carbon source having a plurality of bar-shaped units having a plurality of turning portions as shown in FIG. 3.

### Embodiment 1: Wastewater Treatment Using a Bioreactor of the Present Disclosure

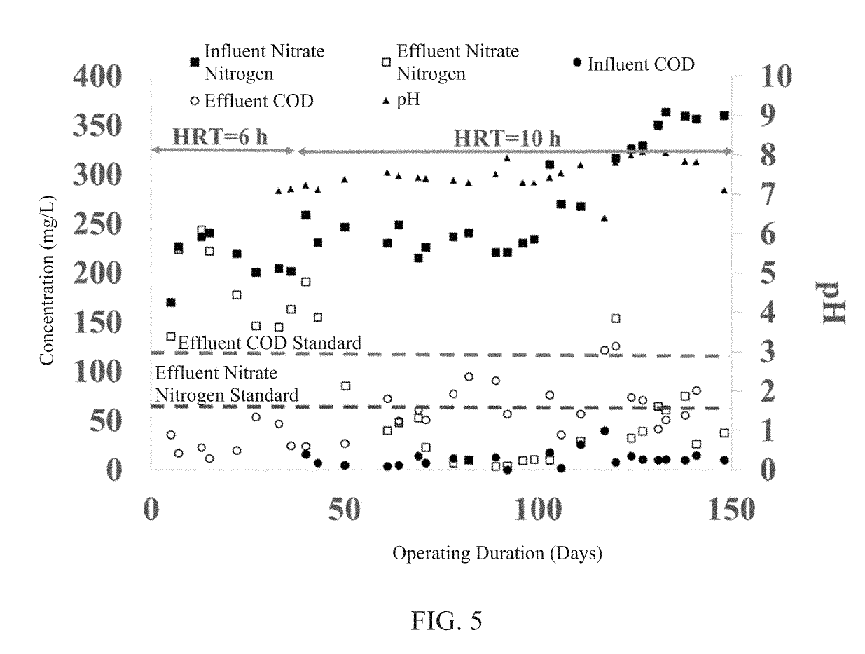

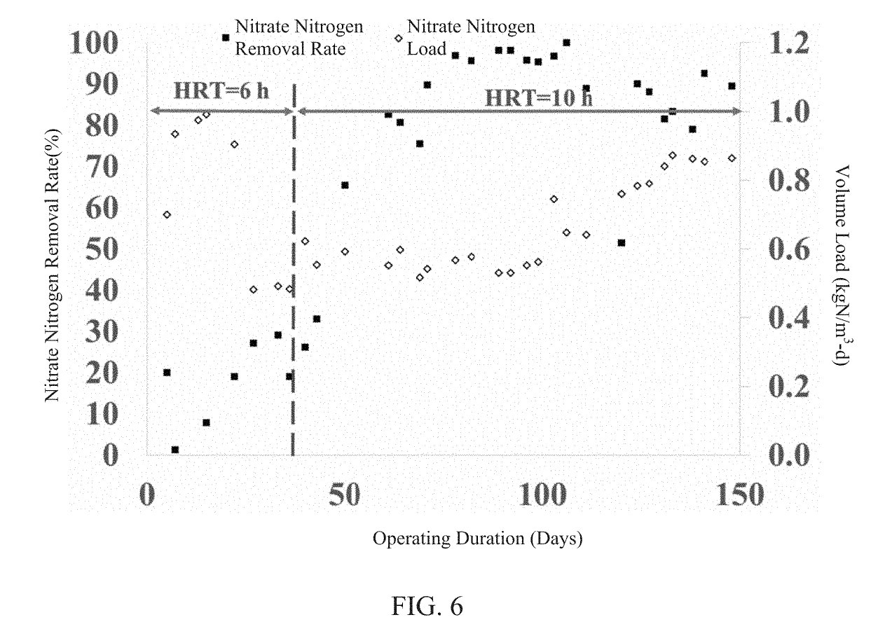

In a cylindrical reactor having a volume of 377 ml, 95 g of a solid carbon source (50 wt % TPS/50 wt % PCL) prepared according to Preparation Example 1 was filled from the bottom upwards into the cylindrical reactor to about 60% of the total height of the cylindrical reactor (about 226.2 ml), bringing the reaction area to 60% of the total cylindrical reactor and having a volume load of 0.4 kgN/m³-d to 0.8 kgN/m³-d. Based on the total volume of the reaction area (about 226.2 ml), the total volume of the plurality of bar-shaped units accounted for 41.2% of the reaction area, and the fluid passage accounted for about 58.8%. 300 ml of denitrifying bacteria sludge (activated sludge) was inoculated at a concentration of 2.94 g/L, wherein the hydraulic retention times (HRT), that is, the durations in which the wastewater was in contact with the solid carbon source, were shown in FIG. 5, the operation was continuous, and the COD value, the nitrate nitrogen content and the pH value of the water were sampled every three days and recorded in FIGS. 5 and 6.

In FIG. 5, solid squares represent the nitrate nitrogen content of the influent, hollow squares represent the nitrate nitrogen content of the effluent, solid circles represent the COD value of the influent, hollow circles represent the COD value of the effluent, and triangles represent the pH value. FIG. 6 is a graph showing the volume load and the removal rate of nitrate nitrogen in the wastewater of Embodiment 1, wherein solid squares represent the removal rate of nitrate nitrogen, and hollow squares represent the nitrate nitrogen load (volume load).

According to the experimental results in FIG. 5, after 147 days (nearly 150 days) of continuous treatment of the solid carbon source, the COD value in the effluent was still lower than 100 mg/L even when the concentration of the influent nitrate nitrogen was gradually increased from 200 mg/L to 350 mg/L. It was found that the solid carbon source of the present disclosure did not collapse to release excessive carbon, after 150 days of treatment. After using the wastewater treatment of the solid carbon source of the present disclosure, the nitrate nitrogen content was reduced after 24 days, and significantly reduced after 50 days. On the 60th day of treatment, the removal rate of the nitrate nitrogen content of the effluent (less than 50 mg/L) reached about 80%.

Moreover, from 100^{th} to 150^{th} day in FIG. 5, at the most activated time (about 125^{th} day) of the oxidation of the nitrate nitrogen, the nitrate nitrogen content of the influent was greater than 350 mg/L, and the nitrate nitrogen content of the effluent was less than 50 mg/L. As the COD of the influent at this time was less than 50 mg/L, it can be appreciated that the carbon source for the denitrifying bacteria in the activated sludge came from the solid carbon source of the present disclosure, in other words, the carbon released by the solid carbon source was enough to sustain the carbon source needed by the denitrification of the denitrifying bacteria. Furthermore, the COD of the effluent at this time was less than 50 mg/L, it can be appreciated that most of the carbon released by the solid carbon source was used by the microbes, and there was not much excess carbon being wasted.

It can be seen from the graph depicting the volume load and the removal rate of the nitrate nitrogen in the wastewater of the Embodiment 1 of the present disclosure shown in FIG. 6 that, at the initial period of reaction (from the 1^{st} to 27^{th} day), the volume load of the nitrate nitrogen was between 0.8 and 1 with a removal rate between 10% and 20%; after 60 days, the removal rate was raised to above 80%; and after 80 days of treatment, the removal rate was maintained at above 95%.

In addition, taking the data of Embodiment 1 (referring to FIGS. 5 and 6), the removal rate and the volume load of the nitrate nitrogen of different concentrations were tested, and the results were recorded in Table 1.

TABLE 1

| Experimental Concentration | 200 mg/L | 250 mg/L | 300 mg/L | 350 mg/L |
|---|---|---|---|---|
| Days in Operation | 28 | 24 | 23 | 24 |
| Average Nitrate Nitrogen Volume | 0.50 kgN/m³-d | 0.52 kgN/m³-d | 0.65 kgN/m³-d | 0.77 kgN/m³-d |
| Load | | | | |
| Average Nitrate Nitrogen Influent | 234 mg/L | 243 mg/L | 302 mg/L | 357 mg/L |
| Concentration | | | | |
| Average Nitrate Nitrogen Effluent | 43 mg/L | 8 mg/L | 34 mg/L | 46 mg/L |
| Concentration | | | | |
| Average Removal Rate | 82% | 97% | 92% | 89% |

As shown in Table 1, regardless of whether the influent nitrate nitrogen concentration was 200 mg/L, 250 mg/L, 300 mg/L or 350 mg/L, the removal rate was 80% or more, in even better conditions, the removal rate was above 90%, or even as high as 97%.

In the previous embodiment, the influent nitrate nitrogen concentration was maintained at 200 mg/L for 28 days, and then the influent nitrate nitrogen concentration was increased to 250 mg/L for another 24 days, so that the average removal rate is the average removal rate in each of those different periods.

### Embodiment 2: Wastewater Treatment Using a Bioreactor of the Present Disclosure

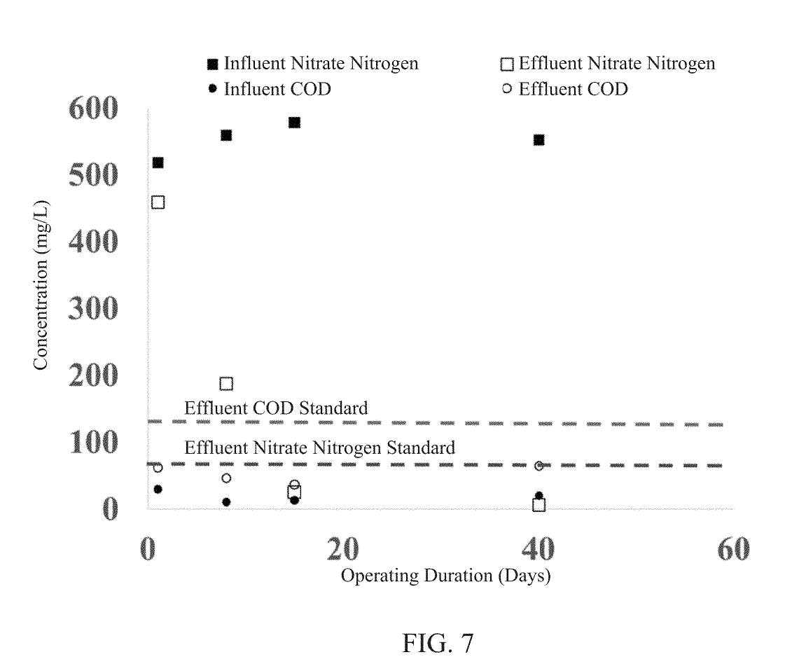

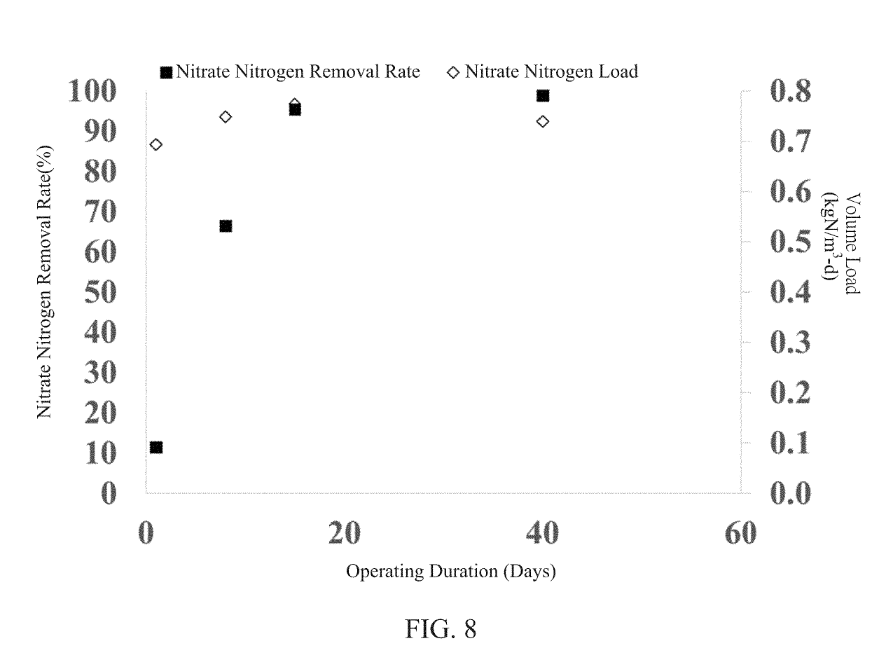

In a cylindrical reactor having a volume of 377 ml, 65.3 g of a solid carbon source (60 wt % TPS/40 wt % PCL) prepared according to Preparation Example 2 was filled from the bottom upwards into the cylindrical reactor to about 60% of the total height of the cylindrical reactor (about 226.2 ml), bringing the reaction area to 60% of the total cylindrical reactor and having a volume load of 0.7 kgN/m³-d to 0.8 kgN/m³-d. The filling ratio of the solid carbon source accounted for 26.5% of the total reaction area, and the ratio of the fluid passage accounted for about 73.5%. 300 ml of denitrifying bacteria sludge (activated sludge) was inoculated at a concentration of 2.94 g/L, the operation was continuous, and the COD value, the nitrate nitrogen content in the water were sampled every 10 days and recorded in FIGS. 7 and 8.

In FIG. 7, solid squares represent the nitrate nitrogen content of the influent, hollow squares represent the nitrate nitrogen content of the effluent, solid circles represent the COD value of the influent, and hollow circles represent the COD value of the effluent. FIG. 8 is a graph showing the volume load and the removal rate of nitrate nitrogen in the wastewater of Embodiment 2, wherein solid squares represent the removal rate of nitrate nitrogen and hollow squares represent the nitrate nitrogen load (volume load).

According to the experimental results in FIGS. 7 and 8, the influent nitrate nitrogen content was maintained at 500 mg/L to 600 mg/L. After 10 days of treatment, the removal rate of the nitrate nitrogen content reached about 90%, the average COD of the effluent was lower than 100 mg/L, and the average nitrate nitrogen concentration was lower than 50 mg/L.

### Embodiment 3: Wastewater Treatment Using a Bioreactor of the Present Disclosure

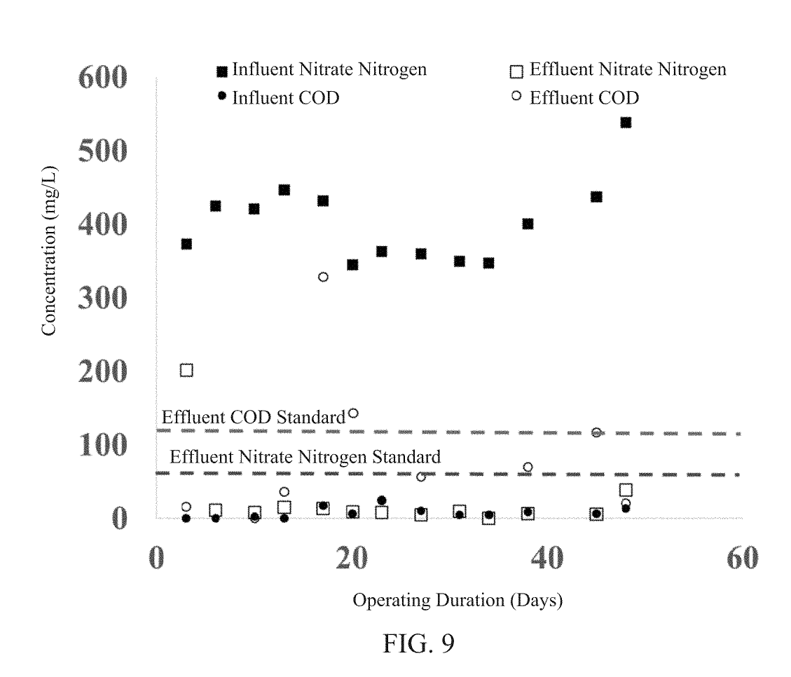

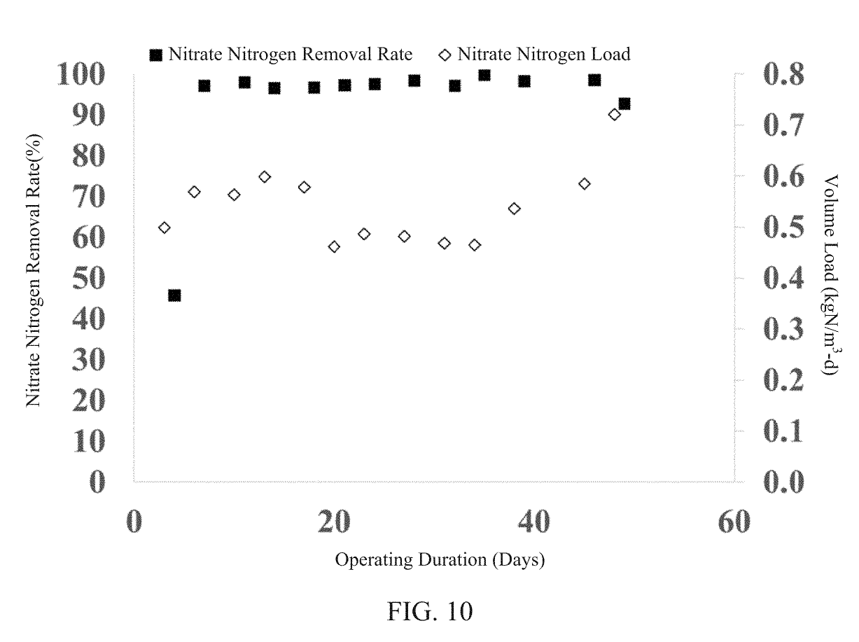

In a cylindrical reactor having a volume of 377 ml, 80.3 g of a solid carbon source (70 wt % TPS/30 wt % PCL) prepared according to Preparation Example 3 was filled from the bottom upwards into the cylindrical reactor to about 60% of the total height of the cylindrical reactor, bringing the reaction area to 60% of the total cylindrical reactor and having a volume load of 0.4 kgN/m³-d to 0.7 kgN/m³-d. The filling ratio of the solid carbon source accounted for 33.3% of the total reaction area, and the ratio of the fluid passage accounted for about 66.7%. 300 ml of denitrifying bacteria sludge (activated sludge) was inoculated at a concentration of 2.94 g/L, the operation was continuous, and the COD value, the nitrate nitrogen content in the water were sampled every 3 days and recorded in FIGS. 9 and 10.

In FIG. 9, solid squares represent the nitrate nitrogen content of the influent, hollow squares represent the nitrate nitrogen content of the effluent, solid circles represent the COD value of the influent, and hollow circles represent the COD value of the effluent. FIG. 10 is a graph showing the volume load and the removal rate of nitrate nitrogen in the wastewater of Embodiment 3, wherein solid squares represent the removal rate of nitrate nitrogen and hollow squares represent the nitrate nitrogen load (volume load).

According to the experimental results in FIGS. 9 and 10, wastewater was treated using the bioreactor of the present disclosure, the influent nitrate nitrogen content gradually increased from 400 mg/L to 500 mg/L. The volume load gradually increased from 0.5 kgN/m³-d to 0.7 kgN/m³-d, and the removal rate of the nitrate nitrogen content was still maintained above 90% with the average COD of the effluent lower than 100 mg/L, and the average nitrate nitrogen concentration lower than 50 mg/L.

### Embodiment 4: Wastewater Treatment Using a Bioreactor of the Present Disclosure

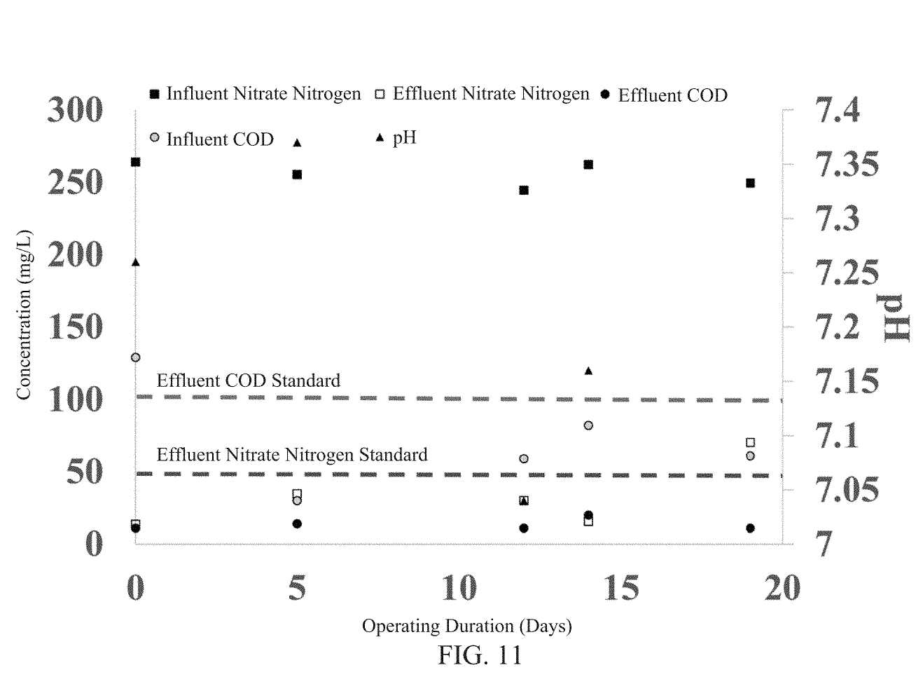

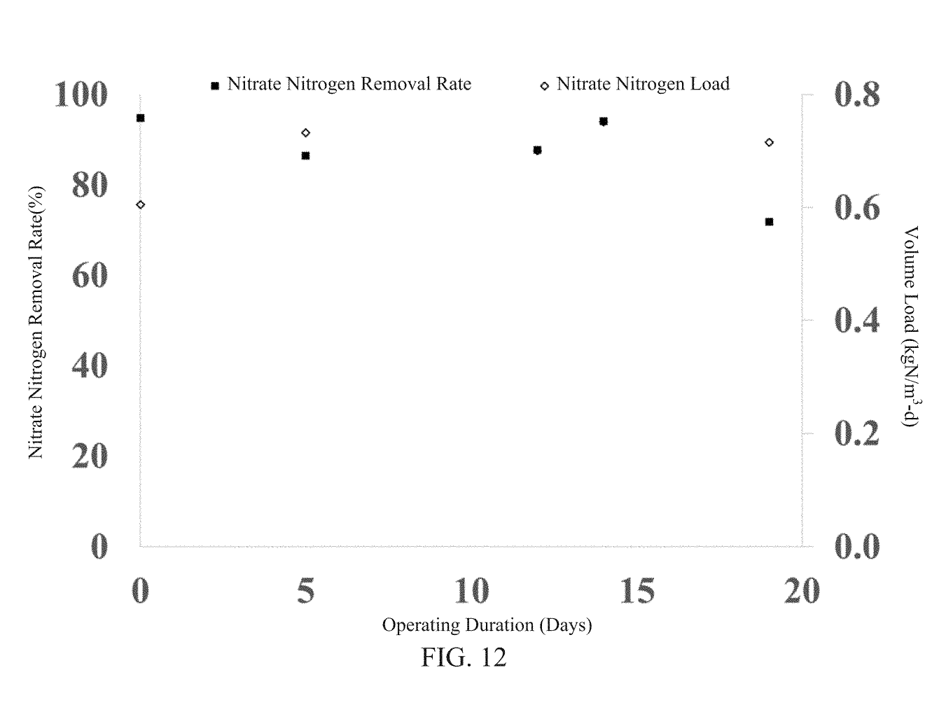

In a cylindrical reactor having a volume of 377 ml, 60.8 g of a solid carbon source (50 wt % TPS/50 wt % PBAT) prepared according to Preparation Example 4 was filled from the bottom upwards into the cylindrical reactor to about 60% (about 226.2 ml) of the total height of the cylindrical reactor, bringing the reaction area to 60% of the total cylindrical reactor and having a volume load of 0.6 kgN/m³-d to 0.8 kgN/m³-d. Based on the total volume of the reaction area (about 226.2 ml), the total volume of the plurality of bar-shaped units was 25.6% of the reaction area, and the fluid passage was about 74.4%. 350 ml of denitrifying bacteria sludge (activated sludge) was inoculated at a concentration of 2.94 g/L, the operation was continuous, and the COD value, the nitrate nitrogen content, and the pH value in the water were sampled every 5 days and recorded in FIGS. 11 and 12.

In FIG. 11, solid squares represent the nitrate nitrogen content of the influent, hollow squares represent the nitrate nitrogen content of the effluent, solid circles represent the COD value of the influent, and hollow circles represent the COD value of the effluent. FIG. 12 is a graph showing the volume load and the removal rate of nitrate nitrogen in the wastewater of Embodiment 4, wherein solid squares represent the removal rate of nitrate nitrogen and hollow squares represent the nitrate nitrogen load (volume load).

According to the experimental results in FIGS. 11 and 12, wastewater was treated using the bioreactor of the present disclosure, the influent nitrate nitrogen content was maintained at 250 mg/L and the removal rate of the nitrate nitrogen content was about 65% to 95%.

### Embodiment 5: Wastewater Treatment Using a Bioreactor of the Present Disclosure

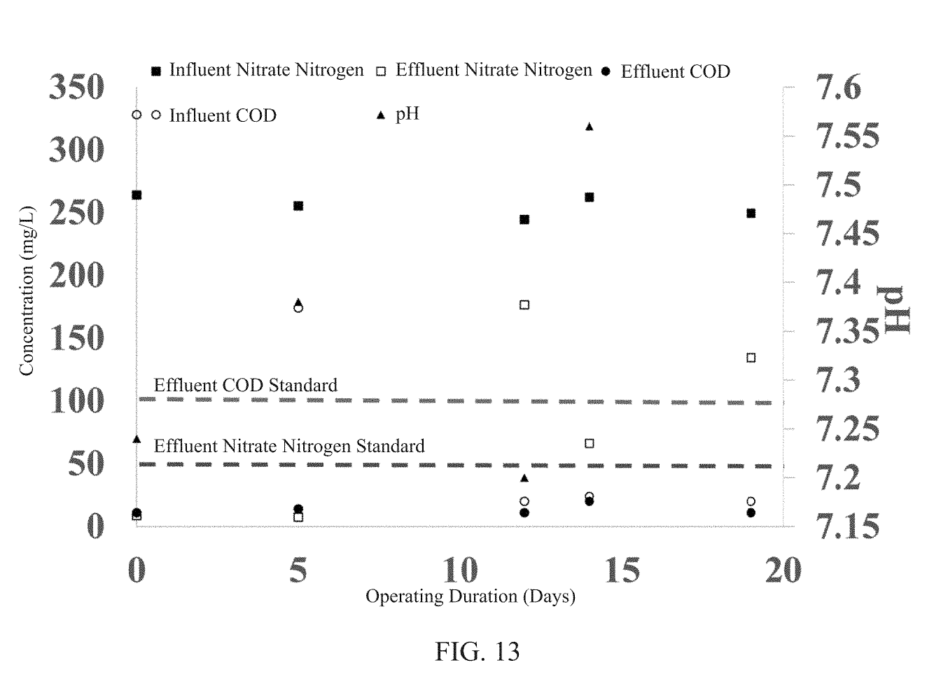

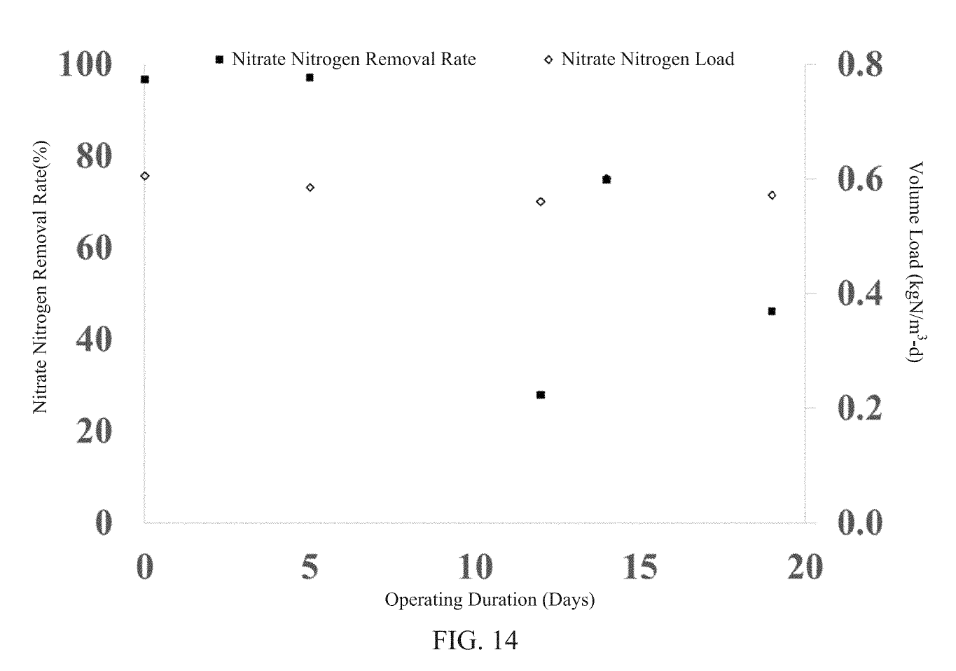

In a cylindrical reactor having a volume of 377 ml, 36.5 g of a solid carbon source (50 wt % TPS/50 wt % PLA) prepared according to Preparation Example 4 was filled from the bottom upwards into the cylindrical reactor to about 60% (about 226.2 ml) of the total height of the cylindrical reactor, bringing the reaction area to 60% of the total cylindrical reactor and having a volume load of 0.6 kgN/m³-d to 0.8 kgN/m³-d. Based on the total volume of the reaction area (about 226.2 ml), the total volume of the plurality of bar-shaped units was 15.4% of the reaction area, and the fluid passage was about 84.6%. 350 ml of denitrifying bacteria sludge (activated sludge) was planted at a concentration of 2.94 g/L, the operation was continuous, and the COD value, the nitrate nitrogen content, and the pH value in the water were sampled every 5 days and recorded in FIGS. 13 and 14.

In FIG. 13, solid squares represent the nitrate nitrogen content of the influent, hollow squares represent the nitrate nitrogen content of the effluent, solid circles represent the COD value of the influent, and hollow circles represent the COD value of the effluent. FIG. 14 is a graph showing the volume load and the removal rate of nitrate nitrogen in the wastewater of Embodiment 5, wherein solid squares represent the removal rate of nitrate nitrogen and hollow squares represent the nitrate nitrogen load (volume load).

According to the experimental results in FIGS. 13 and 14, wastewater was treated using the bioreactor of the present disclosure, the influent nitrate nitrogen content was maintained at 250 mg/L and the removal rate of the nitrate nitrogen content was about 90% or more. In the later period, the removal rate was down from 20% to 60% as there was not enough carbon source.

As can be know from the embodiments of the present disclosure, the solid carbon source of the present disclosure is able to release its carbon slowly over long period. The high specific surface area allows more microbes to make contact with the solid carbon source, effectively using the organic carbon source. Moreover, there is a limited amount of carbon source unused in the effluent, such that the effluent requires no additional carbon removal.

In conclusion, the solid carbon source of the present disclosure has large specific surface area to allow attachment of microbes. As a result, process load is higher. Gas can also be effectively dispelled through the fluid passage, preventing disintegration or dissolving of the frame structure due to excess gas built up at the height of the denitrification reaction. The present disclosure is suitable for wastewater treatment of nitrate nitrogen with a concentration higher than 200 mg/L, and is thus applicable to industrial wastewater treatment.

The above embodiments are only used to illustrate the principles of the present disclosure, and should not be construed as to limit the present disclosure in any way. The above embodiments can be modified by those with ordinary skill in the art without departing from the scope of the present disclosure as defined in the following appended claims.

What is claimed is:

1. A solid carbon source, comprising:
a plurality of bar-shaped units, each of the bar-shaped units having at least a turning portion constituting a position limiting region with at least another bar-shaped unit being disposed therein, and the bar-shaped units being integrated to form a frame structure; and
a plurality of gaps formed between any two of the bar-shaped units for allowing gas or liquid to pass therethrough, wherein the bar-shaped units are made of a composite material having a density of greater than 0.9 g/cm³.

2. The solid carbon source of claim 1, wherein the bar-shaped units each comprise a plurality of turning portions.

3. The solid carbon source of claim 2, wherein the bar-shaped units each include at least an extension portion connected to the turning portion, and the position limiting region is constituted jointly by the turning portion and the extension portion.

4. The solid carbon source of claim 1, wherein the bar-shaped units are offset from one another or wound around one another for the bar-shaped units to integrally form the frame structure.

5. The solid carbon source of claim 1, wherein the bar-shaped units are offset from one another and wound around one another for the bar-shaped units to integrally form the frame structure.

6. The solid carbon source of claim 1, wherein the density of the composite material is in a range of between 0.95 g/cm³ and 1.2 g/cm³.

7. The solid carbon source of claim 1, wherein the composite material has a specific surface area of between 100 cm²/g and 1000 cm²/g.

8. The solid carbon source of claim 1, wherein the composite material is a porous composite material with a porosity of from 10% to 50%, based on a total volume of the composite material.

9. The solid carbon source of claim 1, wherein the bar-shaped units each have an aspect ratio of from 40:1 to 1000:1.

10. The solid carbon source of claim 1, wherein the bar-shaped units are composed of a material comprising starch and a biodegradable polymer with a weight ratio of between 3:7 and 7:3.

11. The solid carbon source of claim 10, wherein the biodegradable polymer is at least one selected from the group consisting of polycaprolactone (PCL), polylactic acid (PLA), poly(butylene adipate-co-terephthalate) (PBAT), polybutylene succinate (PBS) and poly(butylene succinate-co-adipate) (PBSA).

12. The solid carbon source of claim 1, further comprising at least a connecting portion provided among the plurality of bar-shaped units.

13. A bioreactor, comprising:
a body having a retention space, a reaction area within the retention space, an inlet in communication with the retention space, and an outlet in communication with the retention space; and
the solid carbon source of claim 1 placed in the reaction area, wherein the reaction area comprises a fluid passage formed from the plurality of gaps, and the fluid passage is in communication with the inlet and the outlet.

14. The bioreactor of claim 13, wherein the reaction area has a volume of between 50% and 80%, based on a total volume of the retention space.

15. The bioreactor of claim 14, wherein the plurality of bar-shaped units have a volume of between 20% and 60%, based on a total volume of the reaction area.

16. A method for wastewater treatment, comprising bringing wastewater, an activated sludge and the solid carbon source of claim 1 into contact with one another to allow the wastewater to flow through the plurality of gaps to obtain treated wastewater.

17. The method of claim 16, wherein the wastewater comprises nitrate nitrogen of between 50 mg/L and 600 mg/L.

18. The method of claim 16, wherein the wastewater has a pH value of between 6.5 and 8.0.

19. The method of claim 16, wherein the wastewater, the activated sludge and the solid carbon source of claim 1 are brought into contact under a volume load condition of 0.4 kg-N/m³·day to 1.0 kg-N/m³·day to allow the wastewater to pass through the plurality of gaps.

20. The method of claim 16, wherein the treated wastewater has a chemical oxygen demand (COD) of less than 100 mg/L.
